(19) United States
(12) Patent Application Publication
(10) Pub. No.: US 2011/0267476 A1
(43) Pub. Date: Nov. 3, 2011

(54) VIDEO SIGNAL TRANSMITTING DEVICE, RECEIVING DEVICE, AND COMMUNICATION SYSTEM

(76) Inventors: Midori SAKAGUCHI, Tokyo (JP); Hideaki Kosaka, Tokyo (JP); Tetsuro Shida, Tokyo (JP)

(21) Appl. No.: 13/095,242

(22) Filed: Apr. 27, 2011

(30) Foreign Application Priority Data
Apr. 28, 2010 (JP) 2010-103148

(51) Int. Cl. H04N 17/00; H04N 5/04

(52) U.S. Cl. 348/194; 348/500; 348/E17.001; 348/E05.009

(57) ABSTRACT

In a communication system in which a transmitting device transmits a video signal to a receiving device, one or both of these devices includes a beacon analyzer that analyzes beacon signals transmitted by other wireless systems operating in the same frequency band and predicts periods during which beacon transmission is expected. During these predicted periods, video transmission is suspended and the video signal is stored in a buffer in the transmitting device. At the end of each predicted period, the stored video signal is read from the buffer and transmitted without horizontal and vertical blanking periods until the buffering delay is made up. The receiving device displays the received video signal with standard video timing. A normal unbroken video picture is thereby obtained despite beacon interference.

### BACKGROUND OF THE INVENTION

1. Field of the Invention

The present invention relates to a video signal transmitting device that transmits a video signal over a wireless network, and to a video signal receiving device and a communication system.

2. Description of the Related Art

Wireless communication systems are used extensively in business and the home because they eliminate the untidy cabling of wired networks, offer flexibility in the placement of terminal devices, and have other advantages.

Wireless communication systems based on IEEE 802.11a/b/g, a widely used family of wireless LAN standards, operate in the ISM (Industrial, Scientific and Medical) band, which can be legally used without a license. This frequency band may also be used by devices other than wireless LAN devices. Since present wireless communication systems are generally not designed for use in environments in which different systems operate concurrently in the same frequency band, when they are used in such environments, interference between wireless signals occurs, causing communication errors in the wireless communication systems.

In an environment where wireless communication devices of the same type operate simultaneously with the same access control protocol, the devices can analyze each other's transmitted signals and control their transmission timings so as to minimize collision of signals, but in an environment with devices using different protocols, signal collisions cannot be avoided and communication via the colliding signals becomes blocked.

When a new wireless communication system is set up, for example, it is possible to measure the ambient radio-wave environment and select a frequency band in which signal interference is below a certain level, but since the radio-wave environment may change after the system is set up, wireless signal interference has to be monitored and countermeasures have to be taken, such as changing the frequency band.

Japanese Patent Application Publication No. 2003-37529 describes a wireless communication device that avoids mutual interference between signals in wireless communication by controlling itself so as not to carry out wireless communication at timings when received signal strength exceeds a reference signal strength, on the assumption that another wireless communication system is communicating at these timings.

In a video signal transmitting system, however, which has particular timing requirements for signal transmission, a device must transmit its signals in time for the transmitted video picture to be displayed with the correct timing, even if a signal from another wireless system is detected. If the transmission timing of the device were to be controlled simply by halting transmission in synchronization with the timing of signals from another wireless communication system, it might not be possible to transmit the video signal so as to keep up with the video display timing requirements.

Another conceivable strategy is to transmit at a level (signal strength) exceeding a certain level at the timings of the signal from the other wireless communication system, so that the signals transmitted at those timings could be received normally despite the interference from the other wireless communication system, but this strategy would lead to increased power consumption and would interfere with communication by the other wireless communication system.

The invention of Japanese Patent Application Publication No. 2003-37529 avoids mutual interference in wireless communication by deciding that another system is communicating whenever signals having a strength exceeding a reference signal strength are received, and controlling wireless communication so that communication is not carried out at those timings, but this control scheme does not ensure correct display of transmitted video data.

The present invention addresses this situation with the object of enabling a video signal to be transmitted from a video signal transmitting device to a video signal receiving device in such a way that the video signal receiving device can display a video picture with timing in conformity with a video display standard, even in the presence of a wireless LAN beacon that interferes with communication between the video signal transmitting device and the video signal receiving device.

### SUMMARY OF THE INVENTION

A novel communication system, in which a video signal is transmitted by a transmitting device and received by a receiving device, includes a monitoring unit configured to monitor a wireless frequency band in which the transmitting device transmits the video signal to the receiving device, and a transmission period inference unit configured to analyze, when the monitoring unit detects a beacon signal transmitted by another wireless system, the detected beacon signal and predicting a period during which the beacon signal will be transmitted.

During the period of transmission of the beacon signal predicted by the transmission period inference unit, transmission of the video signal from the transmitting device to the receiving device is halted. While the transmission of the video signal is halted, the video signal is stored in a buffer in the transmitting device. After the predicted period of transmission of the beacon signal, the video signal stored in the buffer is transmitted to the receiving device together with video signal synchronizing information.

The receiving device receives the video signal and video signal synchronizing information transmitted from the transmitting device, and reproduces and outputs a video signal conforming with a video display standard on the basis of the received video signal and the received video signal synchronizing information.

The transmitting device transmits the video signal in the order in which the video signal was stored in the buffer, also using blanking periods of the video signal.

The present invention enables a video signal to be transmitted from a video signal transmitting device to a video signal receiving device in such a way that the video signal receiving device can display a video picture with timing conforming to a video display standard, even in the presence of a wireless LAN beacon that interferes with communication between the video signal transmitting device and the video signal receiving device.

### BRIEF DESCRIPTION OF THE DRAWINGS

In the attached drawings:

FIG. 1 shows an exemplary communication system configuration in which the invention may be embodied;

FIG. 2 shows exemplary configurations of the video signal transmitting device and the video signal receiving device in a first embodiment of the invention;

FIGS. 3A to 3D show examples of timings at which the video signal transmitting device stops transmitting in embodiments of the invention;

FIGS. 4A to 4F show examples of timings at which signal transmission and output stop and start in the video signal transmitting device and the video signal receiving device, and corresponding changes in the quantities of data in buffers provided in the video signal transmitting device and video signal receiving device in embodiments of the invention;

FIG. 5 shows exemplary configurations of the video signal transmitting device and the video signal receiving device in a second embodiment of the invention;

FIG. 6 shows exemplary configurations of the video signal transmitting device and the video signal receiving device in a third embodiment of the invention;

FIG. 7 shows exemplary configurations of the video signal transmitting device and the video signal receiving device in a fifth embodiment of the invention; and

FIG. 8 shows exemplary configurations of the video signal transmitting device and the video signal receiving device in a sixth embodiment of the invention.

### DETAILED DESCRIPTION OF THE INVENTION

### First Embodiment

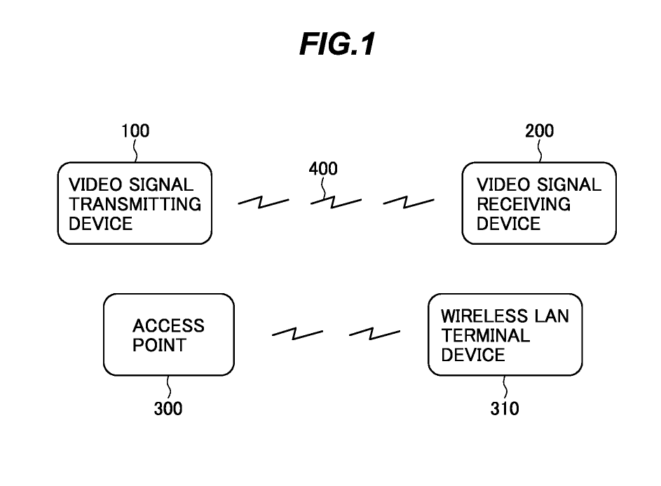

The first embodiment will be described with reference to FIGS. 1, 2, 3A to 3D, and 4A to 4F. FIG. 1 shows an exemplary communication system configuration in which the invention may be embodied.

The illustrated communication system includes a video signal transmitting device 100 and a video signal receiving device 200 that use a predetermined (allocated) wireless frequency band to transmit and receive a video signal and other data over a wireless communication network 400. The transmitting device 100 and receiving device 200 are assumed to have synchronized time information.

The present invention solves the problem of transmission of a video signal from the video signal transmitting device 100 to the video signal receiving device 200 in the presence of a wireless system that uses the same wireless frequency band as used by the wireless communication network 400 (or a wireless frequency band partly overlapping that band), for example, a wireless system including an access point (AP) 300 and a wireless LAN terminal device 310, constituting a wireless LAN, in which the access point 300 periodically transmits a wireless LAN beacon, with a predetermined interval, using that wireless frequency band. In the following description, the video signal transmitting device is referred to simply as the transmitting device and the video signal receiving device is referred to simply as the receiving device.

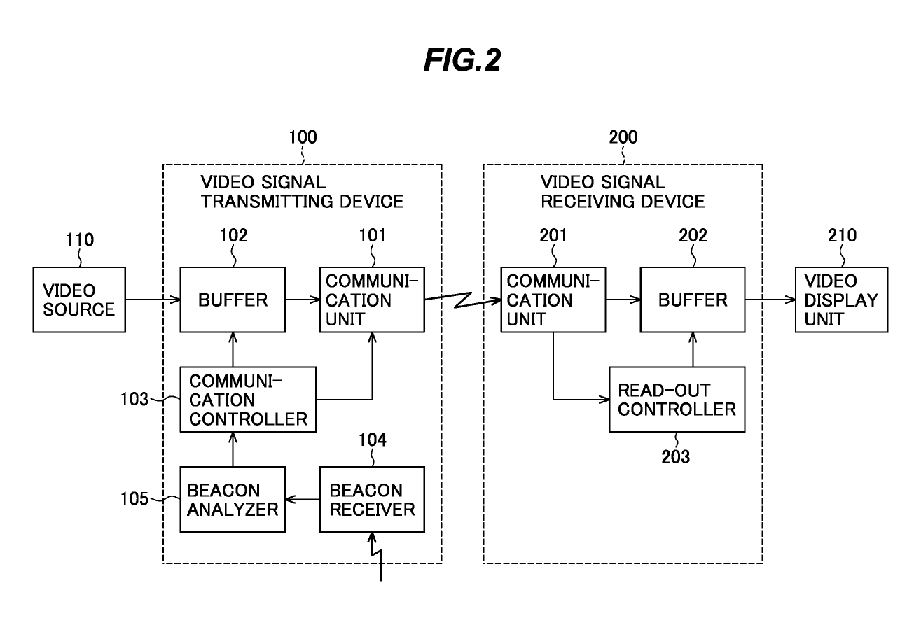

FIG. 2 shows exemplary configurations of the transmitting device 100 and the receiving device 200 in the first embodiment. The illustrated transmitting device 100 has a communication unit 101, a buffer 102, a communication controller 103, a beacon receiver 104, and a beacon analyzer 105.

The transmitting device 100 receives a video signal supplied at timings meeting (conforming to) a predetermined standard from a video source 110. The video signal is accompanied by video signal synchronizing information.

The buffer 102 stores the video signal and the video signal synchronizing information supplied from the video source 110.

The communication unit 101 reads the video signal and the video signal synchronizing information from the buffer 102 and transmits them, together with other data, to the receiving device 200. The other data include information used for control of video signal transmission, for example, information indicating beacon analysis results as described below. The transmitted video signal is, for example, a 1080p 60-Hz high-definition video signal transmitted without compression.

The beacon receiver 104 monitors the wireless frequency band (the predetermined wireless frequency band mentioned above) used for transmission of the video signal and other data, detects or receives the wireless LAN beacon, notifies the beacon analyzer 105 of the wireless LAN beacon reception time (detection timing), and passes the wireless LAN beacon signal to the beacon analyzer 105.

The beacon analyzer 105 analyzes the wireless LAN beacon received from the beacon receiver 104, and based on the wireless LAN beacon reception time (detection timing), and on information indicating the beacon transmission interval and information indicating the beacon transmission time included in the wireless LAN beacon, predicts or infers the timing (occupation period) when a subsequent, for example the next, wireless LAN beacon will be transmitted, and sends the result of its prediction or inference to the communication controller 103 to control transmission by the transmitting device. Information indicating the inferred occupation period and information indicating the wireless LAN beacon transmission interval are sent from the communication unit 101 to the receiving device 200.

This ‘occupation period’ refers to a subsequent period, or the next period, in which the wireless frequency band will be periodically occupied, assuming that the wireless LAN beacon will be transmitted periodically with the acquired beacon transmission interval, the occupation continuing for the time indicated by the acquired transmission time information.

A wireless LAN beacon is a frame sent from an access point with a predetermined transmission interval. The periods during which the wireless LAN beacon will be transmitted (occupation periods) can be inferred because the wireless LAN beacon includes an SSID (Service Set Identifier) or a BSSID (Basic Service Set Identification) that gives information identifying the wireless LAN network, and information indicating the wireless LAN beacon transmission interval (Beacon Interval).

The beacon analyzer 105 accordingly infers the periods (occupation periods) during which the wireless LAN beacon will be transmitted, on the basis of the acquired wireless LAN beacon reception time and wireless LAN beacon information, and notifies the communication controller 103 of the inferred occupation periods.

The communication controller 103 controls the communication unit 101 so as to halt transmission of the video signal and halt read-out of the video signal from the buffer 102 during the inferred occupation periods, and sends information indicating the occupation periods to the receiving device 200.

No valid video signal is transmitted during blanking periods, so transmission by the communication unit 101 is not halted when a blanking signal overlaps a wireless LAN beacon occupation period.

The receiving device 200 shown in FIG. 2 comprises a communication unit 201, a buffer 202, and a read-out controller 203, and receives a video signal and other data using the predetermined (allocated) wireless frequency band.

The receiving device 200 receives the video signal and the video signal synchronizing information sent from the transmitting device 100, for example, and stores them in the buffer 202. The stored video signal and video signal synchronizing information are read from the buffer 202 on command from the read-out controller 203, at timings conforming with specified video display timings, and output to the video display unit 210.

The communication unit 201 receives the video signal, the video signal synchronizing information, the information indicating beacon occupation periods, and the beacon transmission interval information transmitted from the transmitting device 100.

The buffer 202 stores the video signal and the video signal synchronizing information received by the communication unit 201.

The video signal synchronizing information and the wireless LAN beacon analysis results, that is, the information indicating predicted beacon occupation periods and information indicting the beacon transmission interval received by the communication unit 201, are sent to the read-out controller 203.

The read-out controller 203 controls read-out from the buffer 202, based on the video signal synchronizing information, the information indicating beacon occupation periods, and the beacon transmission interval information sent from the transmitting device 100, in such a way that sufficient video signal is stored in the buffer 202 before read-out begins, making allowances for beacon occupation periods. This permits a normal unbroken video picture to be displayed by the video display unit 210.

The longer an occupation period is, the more data must be stored in the buffer 202; similarly, the shorter the beacon transmission interval is, the more data must be stored in the buffer 202. When a video signal blanking period overlaps a beacon occupation period, the greater the degree of overlap is, the less data need be stored in the buffer 202. The amount of data to be stored in the buffer 202 is determined and read-out is controlled from combined consideration of these relationships.

After read-out begins, the read-out controller 203 reads the video signal stored in the buffer 202 with timings conforming to the video display standard so as not to break the video stream, and supplies the signal continuously to the video display unit 210, enabling the video display unit 210 to display a normal video picture. When the read-out controller 203 reads the video signal from the buffer 202, it also reads the video signal synchronizing information, generates blanking period synchronizing signals, reconstructs the video signal, including its synchronizing signals, and supplies the reconstructed signal to the video display unit 210.

The process in which read-out is started after a sufficient quantity of video signal has been stored in the buffer 202, that is, the read-out start control process described above, is a process that determines the quantity of data to be stored in the buffer before read-out starts, and is also a process that sets an upper limit on the quantity of data stored in the buffer 202, that is, sets the capacity that needs to be reserved for the buffer 202. The advantage of placing an upper limit on the quantity of data stored in the buffer 202 and reserving that capacity in the buffer 202 for storing video signals during video signal transmission and reception is that repeated calculation of the necessary capacity is unnecessary, regardless of changes in the quantity of video signal data stored in the buffer 202.

Also, prediction of the times when video signal transmission must be halted to avoid wireless LAN beacon interference, based on beacon occupation periods, the wireless LAN beacon transmission interval, and the video synchronizing information, and determination of the capacity of the buffer 202 based on the predicted periods enables the unbroken display of a video picture with timings in conformity with the video display standard.

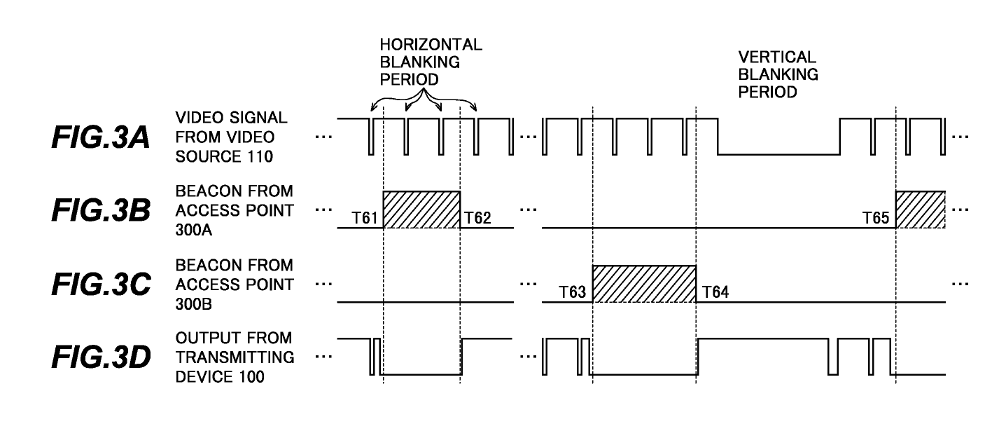

Examples of timings at which the communication controller 103 halts transmission will be described below with reference to FIGS. 3A to 3D. The horizontal axis in FIGS. 3A to 3D represents time. FIGS. 3A and 3B assume a case in which two access points 300A, 300B are operating in the surrounding vicinity.

FIG. 3A shows the video signal supplied from the video source 110 to the transmitting device 100 at timings meeting a video signal standard. The video signal includes periodic periods, referred to as horizontal blanking periods and vertical blanking periods, during which the video signal is not transmitted. During normal operation, the transmitting device 100 transmits the video signal supplied from the video source 110 to the receiving device 200 without delay, that is, with the same timings.

FIGS. 3B and 3C illustrate a situation in which the first access point 300A and the second access point 300B use the same wireless frequency band as the transmitting device 100 to transmit wireless LAN beacons that interfere with communication between the transmitting device 100 and receiving device 200 during the periods (timings) from time T61 to time T62 and time T63 to time T64. Access points can be set to transmit beacons of various durations and various intervals.

FIG. 3D shows the transmitted output of the transmitting device 100. In the example shown in FIG. 3D, the transmission of signals by the transmitting device 100 is halted during the periods from time T61 to time T62 and from time T63 to time T64.

Based on inferences made by the beacon analyzer 105, the communication controller 103 in the transmitting device 100 instructs the communication unit 101 to halt read-out of data from the buffer 102, and to halt transmission and output, during the periods when wireless LAN beacons are transmitted from the first access point 300A and second access point 300B, that is, the periods from time T61 to time T62 and from time T63 to time T64. Since read-out is halted, the video signal continuously supplied from the video source 110 accumulates in the buffer 102.

After each period during which transmission is halted, the communication controller 103 gives instructions to transmit the data that have accumulated in the buffer 102 sequentially (in the order in which the data were stored in the buffer 102), also using the blanking periods. ‘To transmit data, also using the blanking periods’ means that the transmission of the video signal (the valid video signal) in each subsequent horizontal period starts without the provision of a horizontal blanking period at the end of the preceding horizontal period, and that the transmission of the video signal in each subsequent vertical period starts without the provision of a vertical blanking period at the end of the preceding vertical period.

Both the video signal and the video signal synchronizing information are transmitted in the manner described above. The video signal synchronizing information represents the position (position relative to the video signal on the time axis) and waveform (length on the time axis and level at each timing) of the synchronizing signals included in the video signal.

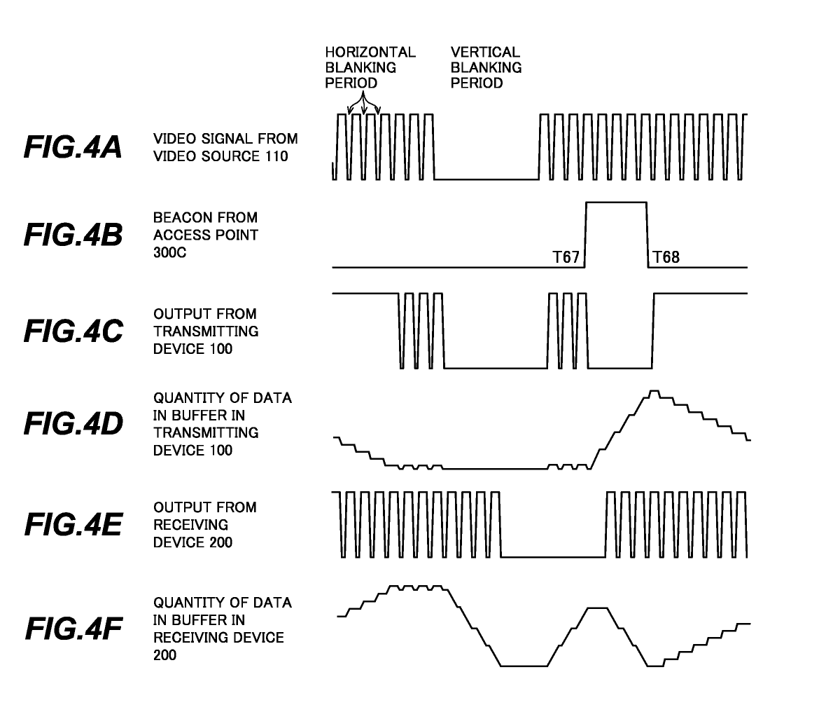

FIGS. 4A to 4F show the beacon signal of a nearby access point 300C, the video signals output by the transmitting device 100, video source 110, and receiving device 200, and the quantities of data in the buffer 102 in the transmitting device 100 and the buffer 202 in the receiving device 200. FIGS. 4A to 4F assume a case in which only one access point 300C is operating in the nearby vicinity.

FIG. 4A shows the signal output from the video source 110 to the transmitting device 100, which is transmitted with timings conforming to a video display standard. FIG. 4B shows the beacon transmitted from the access point 300C. As shown in FIG. 4B, the access point 300C transmits the beacon in the period from time T67 to time T68, and as shown in FIG. 4C, the transmitting device 100 halts transmission during that period.

The quantity of data stored in the buffer 102 of the transmitting device 100, shown in FIG. 4D, increases during the period from time T67 to time T68 during which video signal transmission is halted. After that, the data that that was not transmitted during this halt period is transmitted, using the blanking periods as well, so the quantity of data in the buffer 102 of the transmitting device 100 decreases during each blanking period.

FIG. 4F shows the change in the quantity of data in the buffer 202 of the receiving device 200. FIG. 4E shows the output from the receiving device 200 to the video display unit 210.

In the receiving device 200, the communication unit 201 receives the video signal, video signal synchronizing information, information indicating beacon occupation periods, and beacon transmission interval information, and on the basis of the information indicating the beacon occupation periods, the read-out controller 203 starts read-out of the video signal from the buffer 202 at timings that enable a normal video picture to be displayed by the video display unit 210.

In this embodiment, in a communication network including a transmitting device 100 and a receiving device 200 as described above, when there is an access point that transmits a wireless LAN beacon in the same frequency band, transmission is halted during the periods occupied by the wireless LAN beacon transmitted by the access point. This configuration suppresses the effect of interference by the wireless LAN beacon transmitted by the access point and provides transmission and reception with stable quality between the transmitting device 100 and the receiving device 200.

Since this embodiment does not employ a process that raises the level of the transmitted signal in order to avoid interference by the wireless LAN beacon, such interference can be avoided without increasing the power consumed by the transmitting device 100, and the risk that the transmitted signal will travel so far that it might be eavesdropped on can be minimized.

Because video signal synchronizing information is transmitted from the transmitting device 100 to the receiving device 200, this embodiment ensures that the video picture can be displayed at the receiving device 200 with standard video display timings.

In the above example, both information indicating beacon occupation periods and information indicating beacon transmission interval are transmitted from the transmitting device 100 to the receiving device 200. In an alternative example, only one of the above information is transmitted, and the receiving device controls read-out from its buffer 202 based on the transmitted information.

### Second Embodiment

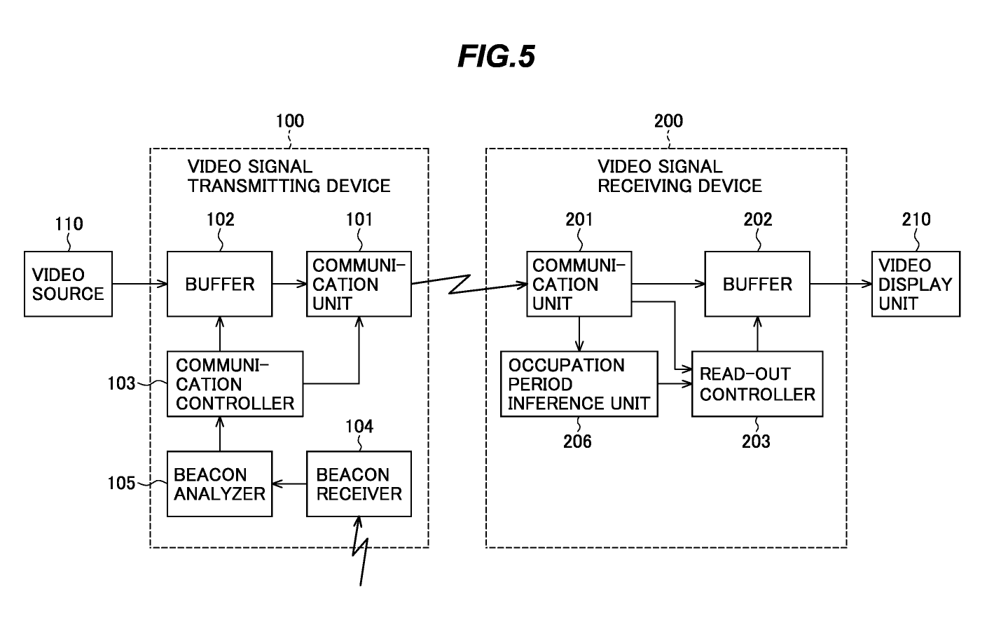

FIG. 5 shows exemplary configurations of the video signal transmitting device and the video signal receiving device in the second embodiment. Reference characters in FIG. 5 that are the same as in FIG. 2 indicate the same or corresponding elements.

The receiving device 200 shown in FIG. 5 is generally similar to the receiving device 200 shown in FIG. 2, but has an occupation period inference unit 206.

In the first embodiment, information indicating the beacon occupation periods inferred by the beacon analyzer 105 of the transmitting device 100 is transmitted to the receiving device 200. In the second embodiment, information indicating the wireless LAN beacon detection timings obtained by the beacon analyzer 105 in the transmitting device 100 is transmitted from the transmitting device 100 to the receiving device 200, together with the video signal and video signal synchronization information, but wireless LAN beacon transmission interval information and information indicating beacon occupation periods is not transmitted to the receiving device.

In the receiving device 200, the communication unit 201 receives the video signal, the video signal synchronizing information, and the information indicating wireless LAN beacon detection timings, supplies the video signal synchronizing information to the read-out controller 203, and supplies the information indicating wireless LAN beacon detection timings to the occupation period inference unit 206. The occupation period inference unit 206 infers beacon occupation periods from the supplied video signal synchronizing information, the information indicating wireless LAN beacon detection timings, and information indicating typical wireless LAN beacon transmission intervals. The information indicating typical wireless LAN beacon transmission intervals is prestored in the occupation period inference unit 206. The occupation period inference unit 206 supplies the results of its inferences to the read-out controller 203.

Based on the information indicating beacon occupation periods inferred by the occupation period inference unit 206, the information indicating typical wireless LAN beacon transmission intervals, and the video signal synchronizing information transmitted from the transmitting device 100, the read-out controller 203 controls read-out from the buffer 202 as in the first embodiment. The video signal and the video signal synchronizing information are read out from the buffer 202 and supplied to the video display unit 210 with timings conforming to a video display standard, enabling the video display unit 210 to display a normal video picture.

An upper limit is set for the capacity of the buffer 202, using a predetermined value based on typical wireless LAN beacon occupation periods. What is meant by a predetermined value is a value high enough to forestall the necessity of changing the memory size during the operation of the system.

The above configuration provides effects similar to those obtained in the first embodiment. In addition, since the control of data read-out from the buffer 202 for video display is determined from the video signal synchronizing information transmitted from the transmitting device 100 and wireless LAN beacon occupation periods inferred from typical wireless LAN beacon transmission intervals, the amount of information transmitted from the transmitting device to the receiving device can be reduced.

### Third Embodiment

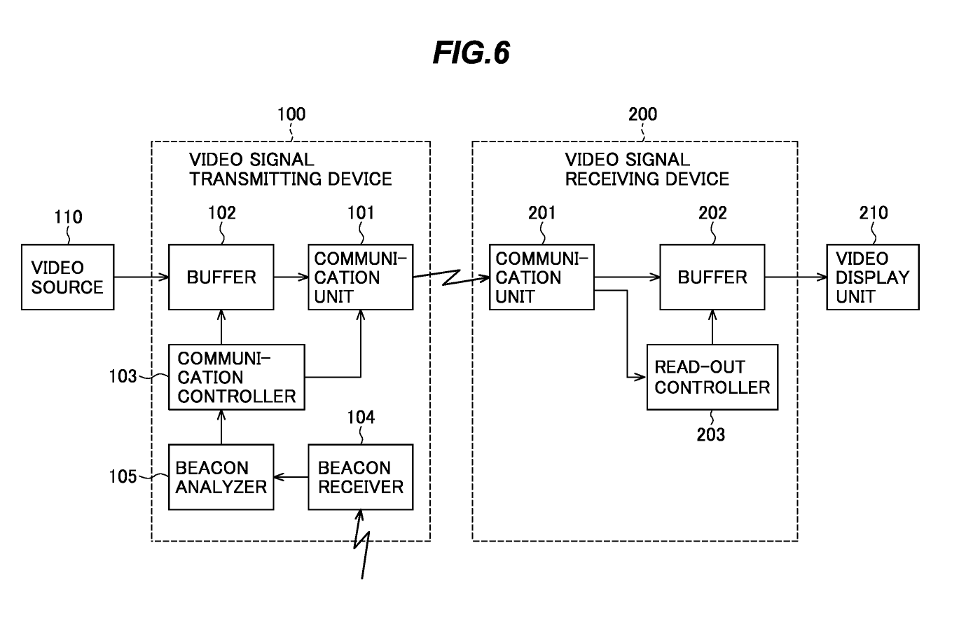

FIG. 6 shows exemplary configurations of the transmitting device 100 and the receiving device 200 in a third embodiment. Reference characters in FIG. 6 that are the same as in FIG. 2 indicate the same or corresponding elements.

The receiving device 200 shown in FIG. 6 is generally similar to the receiving device 200 shown in FIG. 5, but has no occupation period inference unit 206.

In the second embodiment, information indicating the wireless LAN beacon detection timings obtained by the beacon analyzer 105 of the transmitting device 100 is transmitted from the transmitting device 100 to the receiving device 200 together with the video signal and video signal synchronizing information, while in the third embodiment, the video signal and video signal synchronizing information are transmitted to the receiving device 200 but information indicating wireless LAN beacon detection timings is not transmitted to the receiving device 200.

In the receiving device 200, the communication unit 201 receives the video signal and the video signal synchronizing information and supplies them to the read-out controller 203, which, in turn, controls read-out from the buffer 202 on the basis of the video signal synchronizing information supplied from the communication unit 201 and internally prestored information indicating typical wireless LAN beacon transmission intervals. In other words, the video signal and the video signal synchronizing information are read out from the buffer 202 and supplied to the video display unit 210 with timings conforming to a video display standard, enabling the video display unit 210 to display a normal unbroken video picture.

An upper limit is set for the capacity of the buffer 202, using a predetermined value based on the typical wireless LAN beacon occupation periods. What is meant by a predetermined value is a value high enough to forestall the necessity of changing the memory size during the operation of the system.

The above configuration provides effects similar to those obtained in the first embodiment. In addition, since the control of data read-out from the buffer 202 for video display is determined from the video signal synchronizing information transmitted from the transmitting device 100 and information indicating typical wireless LAN beacon transmission intervals, the amount of information transmitted from the transmitting device to the receiving device can be reduced.

### Fourth Embodiment

The transmitting device 100 and receiving device 200 used in the fourth embodiment have the same block configuration as shown in FIG. 2.

In the first embodiment, the read-out controller 203 in the receiving device 200 controls read-out from buffer 202, especially the start of read-out, thus determining the upper limit of the buffer capacity, while in the fourth embodiment, the communication controller 103 in the transmitting device 100 controls read-out from buffer 102, especially the start of read-out, and thus also determines an upper limit for the buffer capacity. The control by the communication controller 103 over the start of read-out from buffer 102, that is the determination of the upper limit, is similar to the control by the read-out controller 203 in the receiving device 200 over the start of read-out from buffer 202 described in the first embodiment.

The beacon analyzer 105 in the transmitting device 100 may also calculate the buffer capacity necessary for unbroken video output at the receiving device 200 and notify the receiving device 200, and the read-out controller 203 in the receiving device 200 may control read-out from buffer 202 on the basis of the buffer capacity notification from the transmitting device.

In this way, the buffer capacity calculations can be carried out all at once in the transmitting device 100, reducing the processing load on the receiving device 200.

### Fifth Embodiment

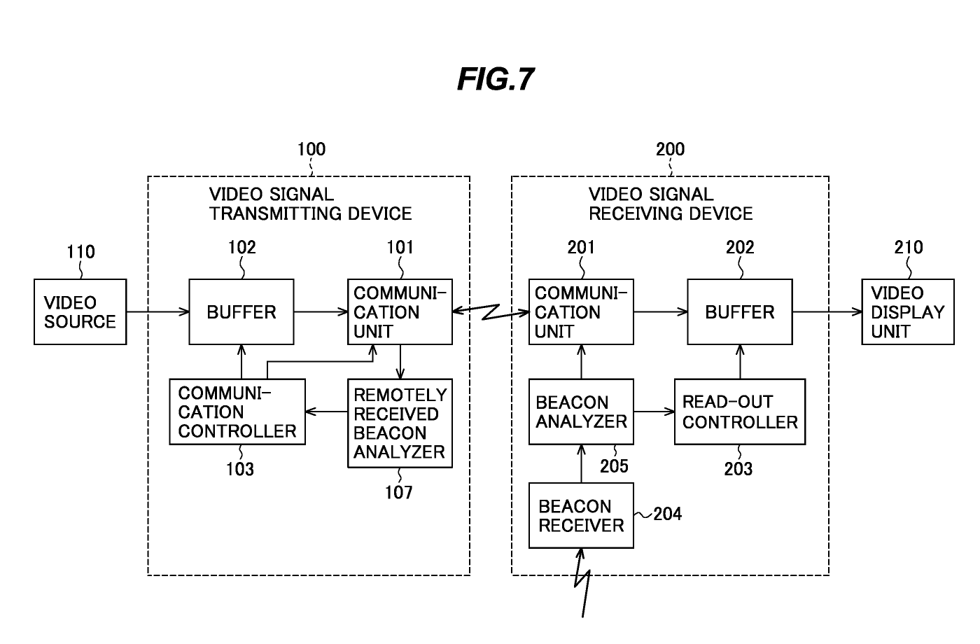

FIG. 7 shows exemplary configurations of the video signal transmitting device and the video signal receiving device in the fifth embodiment. Reference characters in FIG. 7 that are the same as in FIG. 2 indicate the same or corresponding elements. The transmitting device 100 shown in FIG. 7 is generally similar to the transmitting device shown in FIG. 2, except that the transmitting device 100 in FIG. 7 lacks the beacon receiver 104 provided in the transmitting device 100 in FIG. 2, and has a remotely received beacon analyzer 107 instead of the beacon analyzer 105 in FIG. 2.

The receiving device 200 shown in FIG. 7 is generally similar to the receiving device 200 shown in FIG. 2, but has a beacon receiver 204 and a beacon analyzer 205. The communication unit 201 transmits beacon reception status data to the transmitting device 100 and receives video signals etc. from the transmitting device 100.

The beacon receiver 204 monitors the wireless frequency band used by the receiving device 200 to receive video signals and other data from the transmitting device 100, detects or receives wireless LAN beacons, notifies the beacon analyzer 205 of the timing when it receives a wireless LAN beacon signal (detection timing), and passes the wireless LAN beacon signal (the data included in the received wireless LAN beacon signal) to the beacon analyzer 205.

The beacon analyzer 205 analyzes the wireless LAN beacons received from the beacon receiver 204, and based on the wireless LAN beacon reception times (detection timings), and on the information indicating the beacon transmission interval and the information indicating the beacon transmission time, infers the timing when a subsequent, for example the next, wireless LAN beacon will be transmitted (occupation period) and sends the results of inferences and beacon transmission interval information to the read-out controller 203. The communication unit 201 transmits the wireless LAN beacon reception times (detection timings) and the wireless LAN beacon signals to the transmitting device 100 as beacon reception status data.

In the transmitting device 100, the communication unit 101 receives the beacon status data transmitted from the receiving device 200 and sends the received data to the remotely received beacon analyzer 107.

The remotely received beacon analyzer 107 analyzes the beacon reception status data, and on the basis of the wireless LAN beacon reception time at the receiving device 200 and the information indicating the beacon transmission interval included in the wireless LAN beacon, infers the period (occupation period) during which a subsequent, for example the next, wireless LAN beacon will be transmitted, and sends the result of its inference to the communication controller 103.

Based on the results of inference by the remotely received beacon analyzer 107, the communication controller 103 controls the read-out of the video signal and other data from the buffer 102 and the transmission of the video signal by the communication unit 101. Transmission of the video signal and read-out of the video signal from the buffer 102 are halted during beacon occupation periods indicated by the above inference results.

The receiving device 200 receives the video signal and the video signal synchronizing information transmitted from the transmitting device 100, stores them in the buffer 202, and outputs them with timings conforming to a video display standard on command from the read-out controller 203.

The read-out controller 203 in the receiving device 200 controls read-out from the buffer 202 on the basis of the video signal synchronizing information transmitted from the transmitting device 100, the information indicating beacon occupation periods supplied from the beacon analyzer 205, and beacon transmission interval information, in such a way that sufficient video signal is stored in the buffer 202 before read-out begins, making allowances for beacon occupation periods. This permits a normal unbroken video picture to be displayed by the video display unit 210.

After read-out begins, the read-out controller 203 reads the video signal stored in the buffer 202 with timings conforming to the video display standard so as not to break the video stream, and supplies the signal to the video display unit 210 continuously, enabling the video display unit 210 to display a normal video picture. When the read-out controller 203 reads the video signal from the buffer 202, it also reads the video signal synchronizing information, generates blanking period synchronizing signals, reconstructs the video signal, including its synchronizing signals, and supplies the reconstructed signal to the video display unit 210.

With the above configuration, the fifth embodiment also provides effects similar to the effects obtained in the first embodiment.

Since the receiving device 200 detects and analyzes wireless LAN beacons, the load on the transmitting device 100 can be reduced.

In addition, the effect of wireless LAN beacons on the receiving device 200 can be detected and evaluated more directly.

### Sixth Embodiment

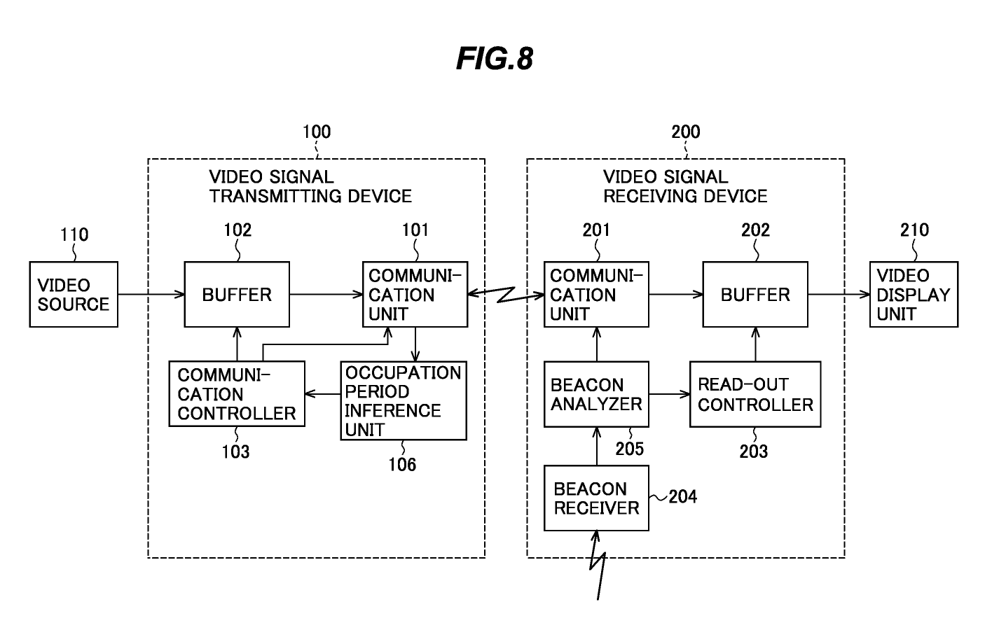

FIG. 8 shows exemplary configurations of the video signal transmitting device and the video signal receiving device in the sixth embodiment. Reference characters in FIG. 8 that are the same as in FIG. 7 indicate the same or corresponding elements. The receiving device 200 shown in FIG. 8 is generally similar to the transmitting device 100 shown in FIG. 7, but has an occupation period inference unit 106 instead of a remotely received beacon analyzer 107.

In the fifth embodiment, the wireless LAN beacon reception times at the receiving device 200 (detection timings) and wireless LAN beacon signals (all data included in the received wireless LAN beacon signals) are transmitted as beacon reception status data to the transmitting device 100, and the remotely received beacon analyzer 107 in the transmitting device 100 infers the beacon occupation periods. In the sixth embodiment, the communication unit 201 transmits information indicating the reception times and transmission interval of the wireless LAN beacon to the transmitting device 100.

In the transmitting device 100, the information transmitted from the receiving device 200 is passed to the occupation period inference unit 106, which, in turn, infers occupation periods on the basis of the supplied information (information indicating the reception times and transmission interval of the wireless LAN beacon).

Information indicating the inferred occupation periods is then supplied to the communication controller 103.

Based on the supplied information indicating occupation periods, the communication controller 103 controls read-out from the buffer and transmission of the video signal by the communication unit 101 as in the fifth embodiment.

With the above configuration, the sixth embodiment provides effects similar to the effects obtained in the fifth embodiment.

In addition, the amount of information transmitted from the receiving device 200 to the transmitting device 100 can be reduced.

Furthermore, the remotely received beacon analyzer 107 can be omitted from the transmitting device 100.

Alternatively, the communication unit 201 in the receiving device 200 may transmit information indicating the inferred beacon occupation period and information indicating the beacon transmission interval obtained by analysis by the beacon analyzer 205 in the receiving device 200 to the communication controller 103, via the communication unit 101 of the transmitting device 100, and the communication controller 103 may control read-out from the buffer 102 and communication by the communication unit 101 according to the transmitted information indicating the inferred occupation period, the information indicating the beacon transmission interval, and the video signal synchronizing information.

### Seventh Embodiment

The transmitting device 100 and receiving device 200 used in the seventh embodiment have the same block configuration as shown in FIG. 7.

In the fifth embodiment, the read-out controller 203 in the receiving device 200 controls read-out from buffer 202, especially the start of read-out, thus determining the upper limit of the buffer capacity, while in the seventh embodiment, the communication controller 103 in the transmitting device 100 controls read-out from buffer 102, especially the start of read-out, and thus also determines an upper limit for the buffer capacity. The control by the communication controller 103 over the start of read-out from buffer 102, that is the determination of the upper limit, is similar to the control by the read-out controller 203 in the receiving device 200 over the start of read-out from buffer 202 described in the fifth embodiment.

The remotely received beacon analyzer 107 in the transmitting device 100 may also calculate the buffer capacity necessary for unbroken video output at the receiving device 200 and notify the receiving device 200, and the read-out controller 203 in the receiving device 200 may control read-out from the buffer 202 on the basis of the buffer capacity notification from the transmitting device.

In this way, the buffer capacity calculations can be carried out all at once in the transmitting device 100, reducing the processing load on the receiving device 200.

In the embodiments described above, it is assumed that beacon signal transmitted by another wireless system is transmitted by an access point included in the wireless system. However, there are wireless systems in which no separate access point is provided but each wireless terminal included in the wireless system transmits the beacon signal. The invention is also applicable to such a situation.

As described from the first to seventh embodiments, the beacon signal may be detected at either the transmitting device 100 or the receiving device 200. Beacon detection may also be carried out at both the transmitting device 100 and the receiving device 200. The monitoring unit recited in the claims refers to the beacon receiver in the transmitting device, the beacon receiver in the receiving device, or the combination of both.

The analysis of the detected beacon signal may be carried out by either the transmitting device 100 or the receiving device 200, one part of the analysis may be carried out by the transmitting device 100 and the remaining part of the analysis may be carried out by the receiving device 200, or similar analyses may be carried out by both the transmitting device 100 and the receiving device 200. The analyzing unit recited in the claims refers to the beacon analyzer 105 or the remotely received beacon analyzer 107 in the transmitting device 100, the beacon analyzer 205 in the receiving device 200, or the combination of both.

Furthermore, the inference of beacon transmission periods may be carried out by the beacon analyzer 105 or 205 or the remotely received beacon analyzer 107, or by the occupation period inference unit 106 or 206. The beacon analyzers 105, 205, the remotely received beacon analyzer 107, and the occupation period inference units 106, 206 are each equivalent to the ‘unit configured to predict a period during which the beacon signal will be transmitted’.

Those skilled in the art will recognize that further variations are possible within the scope of the invention, which is defined in the appended claims.

What is claimed is:

1. A communication system in which a video signal is transmitted by a transmitting device and received by a receiving device, comprising:
a monitoring unit configured to monitor a wireless frequency band in which the transmitting device transmits the video signal to the receiving device; and
a transmission period inference unit configured to analyze, when the monitoring means detects a beacon signal transmitted by another wireless system, the detected beacon signal and predicting a period during which the beacon signal will be transmitted; wherein
during the predicted period of transmission of the beacon signal predicted by the transmission period inference unit, transmission of the video signal from the transmitting device to the receiving device is halted, while the transmission of the video signal is halted the video signal is stored in a buffer in the transmitting device, and after the predicted period of transmission of the beacon signal, the video signal stored in the buffer is transmitted to the receiving device together with video signal synchronizing information;
the receiving device receives the video signal and video signal synchronizing information transmitted from the transmitting device, and reproduces and outputs a video signal conforming with a video display standard on the basis of the received video signal and the received video signal synchronizing information; and
the transmitting device transmits the video signal in an order in which the video signal was stored in the buffer, also using a blanking period of the video signal.

2. The communication system of claim 1, wherein the monitoring unit includes a beacon receiver disposed in the transmitting device.

3. The communication system of claim 1, wherein the transmission period inference unit includes a beacon analyzer disposed in the transmitting device.

4. The communication system of claim 1, wherein the monitoring unit includes a beacon receiver disposed in the receiving device.

5. The communication system of claim 1, wherein the transmission period inference unit includes a beacon analyzer disposed in the receiving device, and information indicating the predicted period of beacon signal transmission and indicating beacon transmission interval, obtained by inference by the beacon analyzer, is transmitted from the receiving device to the transmitting device.

6. The communication system of claim 1, wherein the receiving device has a buffer that stores the video signal and video signal synchronization information transmitted from the transmitting device and a read-out controller that controls read-out from the buffer, and
the read-out controller controls a time at which read-out from the buffer begins, on a basis of the video signal synchronizing information, the predicted period of beacon signal transmission, and the information indicating the beacon transmission interval.

7. The communication system of claim 6, wherein an upper limit is determined for the size of the buffer in the receiving device, on a basis of a predetermined value that assumes a typical wireless LAN beacon transmission interval.

8. The communication system of claim 1, wherein the period during which the transmission of the video signal is halted is predicted from the information indicating the predicted period of beacon transmission, and the size of the buffer in the receiving device is determined so as to enable transmitted data to be buffered for the predicted period.

9. A transmitting device connected to a receiving device through a network, for transmitting an externally supplied video signal to a receiving device, comprising:
a buffer for storing the video signal;
a communication unit for transmitting the video signal stored in the buffer to the receiving device through the network;
a communication controller for halting transmission of the video signal from the transmitting device to the receiving device during a predicted period of beacon signal transmission from another wireless system using a wireless frequency band used for transmission of the video signal from the transmitting device to the receiving device, for storing the video signal in the buffer during the period when the transmission is halted, and after the predicted period of transmission of the beacon signal, for causing the communication unit of the transmitting device to transmit the video signal stored in the buffer, together with video signal synchronizing information, to the receiving device;
wherein the communication controller causes the communication unit to transmit the video signal in an order in which the video signal was stored in the buffer, also using a blanking period of the video signal.

10. The transmitting device of claim 9, further comprising:
a beacon receiver for monitoring a wireless frequency band used for transmission of the video signal from the transmitting device to the receiving device; and
a beacon analyzer for, when a beacon signal is detected by the beacon receiver, analyzing the detected beacon signal to predict the period of beacon signal transmission.

11. The transmitting device of claim 10, wherein the communication unit transmits information indicating the predicted period to the receiving device.

12. The transmitting device of claim 9, wherein:
information indicating time of reception of the beacon signal transmission from the another wireless system and indicating beacon transmission interval, detected as a result of monitoring the wireless frequency band used for transmission of the video signal from the transmitting device to the receiving device, is transmitted from the receiving device to the transmitting device;
the transmitting device further comprises a transmission period inference unit configured to predict a period during which the beacon signal will be transmitted, on a basis of the information transmitted from the receiving device indicating the time of reception of the beacon and the beacon transmission interval; and
the communication controller controls the buffer and the communication unit on a basis of information indicating the period predicted by the transmission period inference unit.

13. A receiving device that receives a video signal transmitted from a transmitting device, comprising;
a communication unit for receiving the video signal and video signal synchronizing information transmitted from the transmitting device;
a buffer for storing the video signal and the video signal synchronizing information received by the communication unit; and
a read-out controller for reading out the stored video signal, in conformity with a video display standard, using the video signal synchronizing information stored in the buffer;
wherein,
transmission of the video signal is halted during a predicted period of beacon signal transmission from another wireless system, and after the predicted period of beacon signal transmission, the video signal and the video signal synchronizing information are transmitted, also using a blanking period of the video signal.

14. The receiving device of claim 13, wherein the read-out controller controls read-out from the buffer on a basis of an assumption that the beacon signal from the another wireless system has a typical wireless LAN beacon transmission interval.

15. The receiving device of claim 13, further comprising:
a beacon receiver for detecting the beacon signal; and
a beacon analyzer for analyzing the detected beacon to obtain beacon transmission interval information and predict the period of beacon transmission;
wherein the read-out controller controls read-out from the buffer on a basis of the beacon transmission interval information obtained by the beacon analyzer and the period of beacon transmission predicted by the beacon analyzer.

16. The receiving device of claim 13, wherein the buffer has a size calculated from the video signal synchronizing information, information indicating the beacon transmission interval, and information indicating the predicted period of beacon signal transmission.
